(19) United States
(12) Patent Application Publication
(10) Pub. No.: US 2025/0238018 A1
(43) Pub. Date: Jul. 24, 2025

(54) CONTROL DEVICE AND COMPUTER-READABLE RECORDING MEDIUM

(71) Applicant: Fanuc Corporation, Minamitsuru-gun, Yamanashi (JP)

(72) Inventors: Naoya KOIDE, Minamitsuru-gun, Yamanashi (JP); Hiroyuki KAWAMURA, Minamitsuru-gun, Yamanashi (JP)

(73) Assignee: Fanuc Corporation, Minamitsuru-gun, Yamanashi (JP)

(21) Appl. No.: 18/881,979

(22) PCT Filed: Aug. 23, 2022
(86) PCT No.: PCT/JP2022/031734

§ 371 Date: Jan. 7, 2025

(51) Int. Cl. G05B 19/416; G05B 19/4103

(52) U.S. Cl. CPC G05B 19/416; G05B 19/4103

(57) ABSTRACT

A control device according to the present disclosure includes: an analysis unit that analyzes instructions by a control program; a corner detection unit that detects, on the basis of the analysis result by the analysis unit, a corner portion at which the direction of a moving route becomes discontinuous; a reference curve creation unit that performs acceleration/deceleration processing on movements before and after the corner portion on the moving route and that creates, as a reference curve, a curve obtained by overlapping the movements by an amount corresponding to a predetermined overlap period; a corner curving unit that creates a moving route curved by inserting, in the corner portion, a curve passing through at least one predetermined reference position on the reference curve; and a curve velocity planning unit that creates a velocity plan relating to movement on the curved moving route. The curve velocity planning unit determines the velocity at the reference position during the movement on the moving route, on the basis of the moving velocity at the reference position on the reference curve.

### CROSS REFERENCE TO RELATED APPLICATIONS

This is the U.S. National Phase application of PCT/JP2022/031734, filed Aug. 23,2022, the disclosure of this application being incorporated herein by reference in its entirety for all purposes.

### TECHNICAL FIELD

The present invention relates to a control device and a computer-readable recording medium.

### BACKGROUND OF THE INVENTION

In an industrial machine, such as a machine tool which has a plurality of feed axes, when the tool is moved along a path where a machining point is discontinuous, such as a right-angle corner, a feedrate is reduced at a corner part or the shape of the corner part is rounded to prevent the occurrence of shocks during passing through the corner (e.g. Patent Literature 1).

### PATENT LITERATURE

[Patent Literature 1] Japanese Patent Laid-Open Publication No. H9-190211

### SUMMARY OF THE INVENTION

For rounding the shape of the corner part, a method for inputting a circular arc, spline curve or clothoid curve may be applied. In such a case, however, if speed control is not devised, a speed waveform of each feed axis will have a wavy shape. It may cause shocks due to a change in acceleration or may lead to a decrease in machining accuracy.

Thus, it is important not only to round the shape of the corner part but also to control the feedrate.

In order to solve the above-described problem, a control device according to the present disclosure refers to a reference curve formed based on the shape of a corner part, and determines curving of the corner part and distribution of a speed to pass along the corner part. The reference curve is formed by smoothly accelerating and decelerating each feed axis along the shape of the corner part.

One aspect of the present disclosure is a control device for driving a feed axis of an industrial machine based on a control program, comprising: an analyzer for analyzing a command in the control program; a corner detector for detecting a corner part at which the direction of a move path is discontinuous, based on a result of an analysis conducted by the analyzer; a reference curve former for conducting acceleration/deceleration processing on movements on move paths in front of and behind the corner part so as to form, as a reference curve, a curve in which the move paths are overlapped by a predetermined overlap time; a corner curve shaper for creating a curved move path on the corner part by inserting a curve that passes at least one predetermined reference position on the reference curve; and a curve speed planner for creating a speed plan concerning to a movement on the curved move path, wherein the curve speed planner determines a speed in the reference position while moving along the move path based on a move speed in the reference position on the reference curve.

Another aspect of the present disclosure is a computer-readable recording medium that records a program for operating a computer as a control device for driving a feed axis of an industrial machine based on a control program, wherein the computer is operated as: an analyzer for analyzing a command in the control program; a corner detector for detecting a corner part at which a direction of a move path is discontinuous based on a result of an analysis conducted by the analyzer; a reference curve former for conducting acceleration/deceleration processing on movements on move paths in front of and behind the corner part so as to form, as a reference curve, a curve in which the move paths are overlapped by a predetermined overlap time; a corner curve shaper for creating a curved move path on the corner part by inserting a curve that passes at least one predetermined reference position on the reference curve; and a curve speed planner for creating a speed plan concerning a movement on the curved move path, and wherein the curve speed planner determines a speed in the reference position while moving along the move path based on a move speed in the reference position on the reference curve.

According to one aspect of the present disclosure, the curving of the corner part and the speed to pass along the corner part are determined based on the reference curve to prevent a speed waveform of each feed axis from being wavy and reduce shocks, and thus machining accuracy is expected to be improved.

### BRIEF DESCRIPTION OF THE DRAWINGS

FIG. 1 is a schematic hardware configuration diagram of a control device according to an embodiment of the present invention;

FIG. 2 is a block diagram schematically showing functions of the control device according to the embodiment of the present invention;

FIG. 3 shows an example of a corner part in a move path;

FIG. 4 is a graph showing an example of a relation between move speeds on move paths when forming a reference curve;

FIG. 5 shows an example of a reference curve formed by a reference curve former; and

FIG. 6 shows an example of a curve inserted into the corner part by a corner curve shaper 130.

A description will now be made about an embodiment of the present invention by referring to the accompanying drawings.

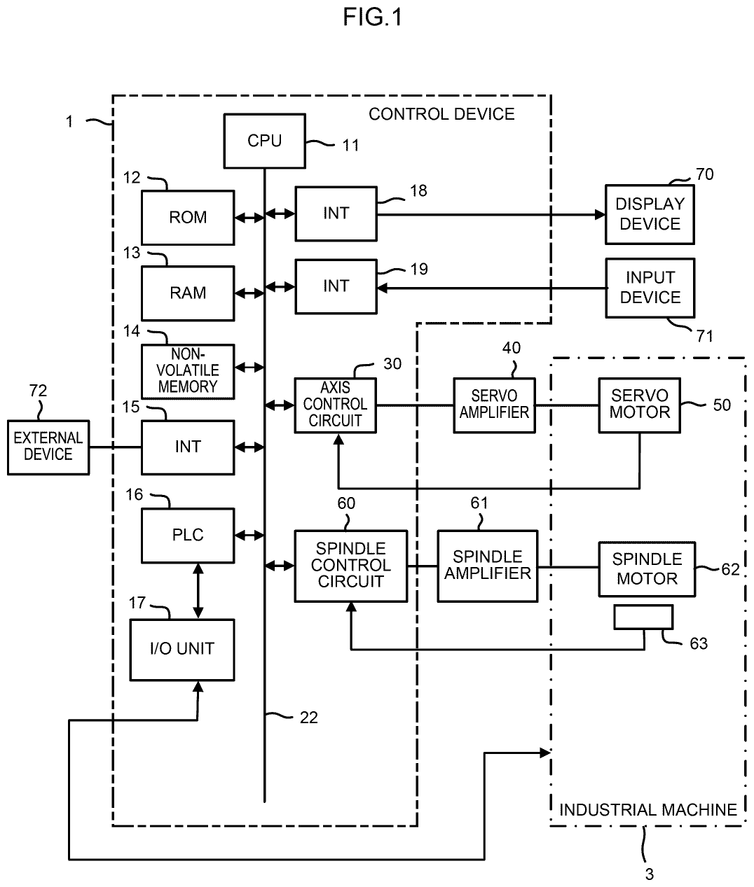

FIG. 1 is a schematic hardware configuration diagram showing main components of a control device according to one embodiment of the present invention. A control device 1 of the invention can be implemented as a control device for controlling industrial machines, such as machine tools and robots, which have a moving object moved by driving a motor. The following description provides an example of the control device 1 that controls a relative position between a tool and a workpiece so as to control a machine tool for machining the workpiece.

The control device 1 of the present invention includes a central processing unit (CPU) 11 which is a processor for controlling the entire control device 1. The CPU 11 reads a system program stored in a read-only memory (ROM) 12 via a bus 22 to control the entire control device 1 according to the system program. A random-access memory (RAM) 13 is configured to temporarily store temporary computation data and pieces of data to be displayed, as well as various pieces of data input from outside.

A non-volatile memory 14 is configured with, for example, a memory or solid state drive (SSD), which is backed up by a battery not shown in the Figure, so that storage conditions can be retained even when a power source of the control device 1 is turned off. The non-volatile memory 14 is configured to store, for example, control programs and pieces of data read from an external device 72 via an interface 15, pieces of data and control programs input through an input device 71, and various data acquired from an industrial machine 3. The control programs and the various data stored in the non-volatile memory 14 may be deployed into the RAM 13 when they are executed/used. Furthermore, the ROM 12 stores various system programs, such as known analysis programs, in advance.

The interface 15 is configured to connect the CPU 11 in the control device 1 to the external device 72, such as a USB. From the external device 72, control programs, parameters and others used for controlling the industrial machine 3 can be read out. In addition to that, control programs, parameters and others edited in the control device 1 can be stored via the external device 72 in external storage means. A programmable logic controller (PLC) 16 is configured to send signals via an I/O unit 17 according to sequence programs stored in the control device 1 to the industrial machine 3 and peripheral devices of the industrial machine 3 (e.g., a turret, an actuator for a robot, sensors mounted on the industrial machine 3), so as to control the industrial machine 3 and the peripheral devices. Furthermore, the PLC 16 receives signals from various switches of an operator's panel disposed on the main body of the industrial machine 3 and signals from the peripheral devices, conducts necessary signal processing, and then transmits the signals to the CPU 11.

A display unit 70 is configured to display various data read into a memory, pieces of data acquired by executing the control programs, the system programs and the like, which are output through an interface 18. The input unit 71 is configured with a keyboard, a pointing device or the like and is configured to transfer commands, data and others according to operations made by an operator to the CPU 11 via an interface 19.

An axis control circuit 30 for controlling axes included in the industrial machine 3 is configured to receive an amount of movement command of an axis from the CPU 11 and then output the command of the axis to a servo amplifier 40. The servo amplifier 40 drives, upon receipt of this command, a servo motor 50 which is configured to move each of moving objects included in the industrial machine 3 along the axis. The servo motor 50 for the axis is built in a position/speed detector to feed a position/speed feedback signal from the position/speed detector back to the axis control circuit 30. The axis control circuit 30 conducts feedback control on the position and the speed of the servo motor 50. Although the hardware configuration diagram in FIG. 1 shows only one axis control circuit 30, one servo amplifier 40 and one servo motor 50, they are actually provided to the number of axes included in the industrial machine 3 to be controlled. For example, when a typical machine tool having linear three axes is controlled, three pairs of the axis control circuit 30, the servo amplifier 40 and the serve motor 50 are provided to move a spindle attached to a tool and a workpiece relatively in the directions of the linear three axes (X-axis, Y-axis, Z-axis).

A spindle control circuit 60 is configured to receive a spindle rotation command and send a spindle speed signal to a spindle amplifier 61. The spindle amplifier 61 is configured to, upon receipt of the spindle speed signal, rotate a spindle motor 62 in the industrial machine 3 at an instructed rotation speed to drive the spindle. To the spindle motor 62, a position coder 63 is coupled. The position coder 63 is synchronized with the rotation of the spindle to thereby output a feedback pulse, and the feedback pulse is read by the CPU 11.

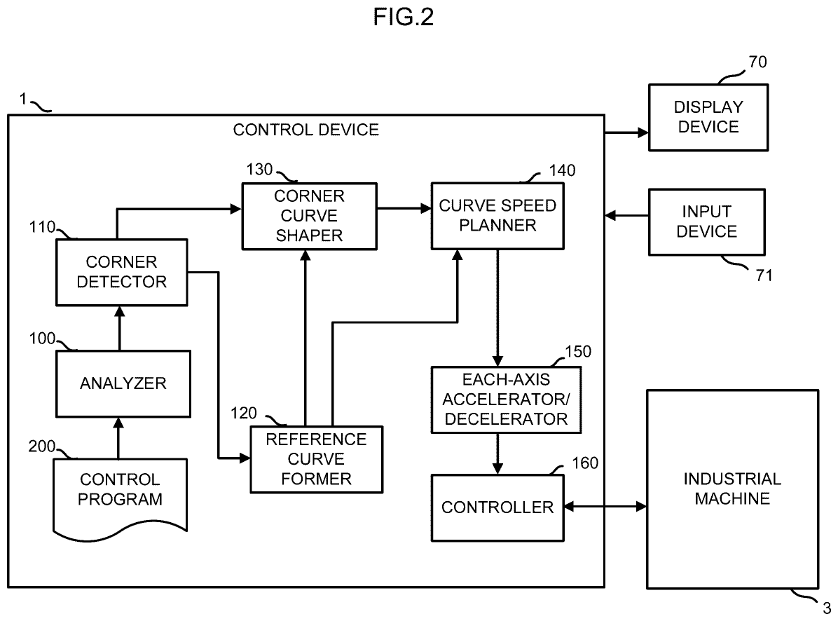

FIG. 2 is a block diagram that schematically shows functions of the control device 1 according to an embodiment of the present invention. The control device 1 according to the embodiment controls a relative position between a rotating tool and a workpiece so as to bring the tool into contact with the workpiece for cutting the workpiece. The various functions of the control device 1 according to the embodiment are implemented in such a way that the CPU 11 included in the control device 1 shown in FIG. 1 executes the system programs to control the operations of the components of the control device 1.

The control device 1 of the embodiment includes an analyzer 100, a corner detector 110, a reference curve former 120, a corner curve shaper 130, a curve speed planner 140, an each-axis accelerator/decelerator 150, and a controller 160. Furthermore, a control program 200 to be used for controlling the industrial machine 3 is stored beforehand in the RAM 13 and the non-volatile memory 14 in the control device 1.

The analyzer 100 is configured to successively read blocks of a control program 200. The analyzer 100 in turn analyzes commands issued by the blocks thus read out. The control program 200 includes commands about a stroke, a move path and a move speed of a feed axis, for instance. The analyzer 100 analyzes these commands to generate data on a movement command for controlling the position of each servo motor 50. In a case where the control program 200 includes a rotation speed command for the spindle, data about a spindle rotation command for controlling the rotation of the spindle motor 62 is generated. It is desirable that the analyzer 100 conducts the analysis by looking ahead the blocks. The analyzer 100 outputs the generated data about the commands to the corner detector 110.

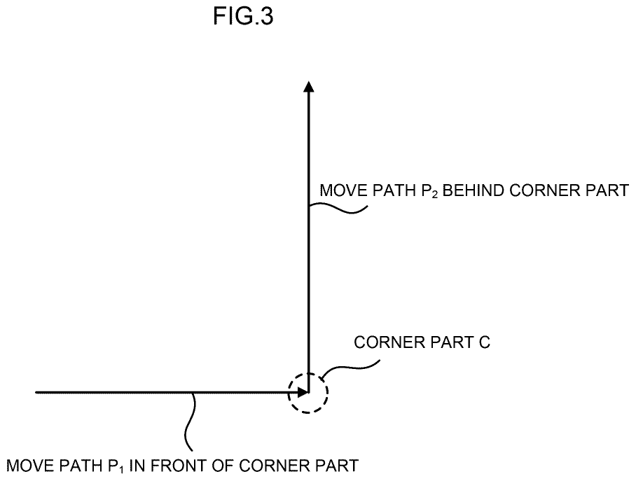

The corner detector 110 is configured to detect a corner part at which the direction of the move path is discontinuous, based on the data about the movement command input from the analyzer 100. In this description, the corner part means a part between two consecutive move paths P₁ and P₂ at which the direction of the move path P₁ in front of this part is discontinuously connected to the direction of the move path P₂ behind this part. FIG. 3 shows an example of the corner part. The example in FIG. 3 shows that the direction of the move path P₁ in front of the corner part is connected at an approximate right angle to the direction of the move path P₂ behind the corner part. In addition to the angle illustrated in FIG. 3, the corner part C may be connected at more acute angle or more obtuse angle. Furthermore, the move paths P₁ and P₂ in front of and behind the corner part are not necessarily straight, and may be in a curve. The corner detector 110 detects a connection point between the move paths based on the data about the movement command input from the analyzer 100. Then, when an angle formed by move paths in front of and behind the connection point is equal to or smaller than a predefined given angle θₜₕ) (θₜₕ<180°, this connection point is detected as a corner part, by way of example.

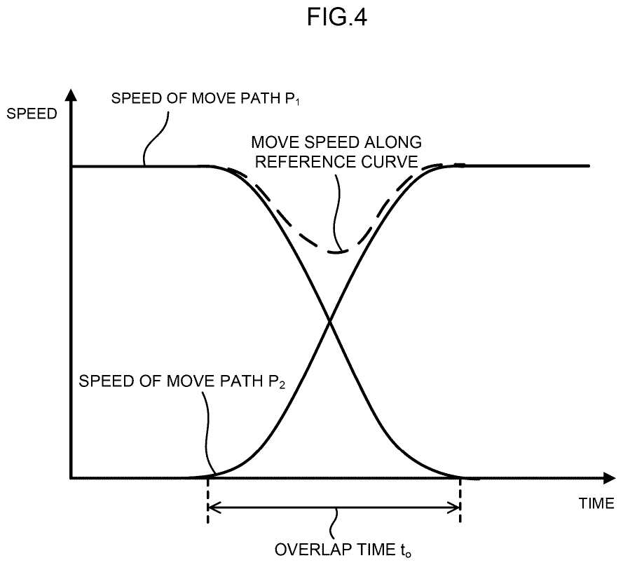

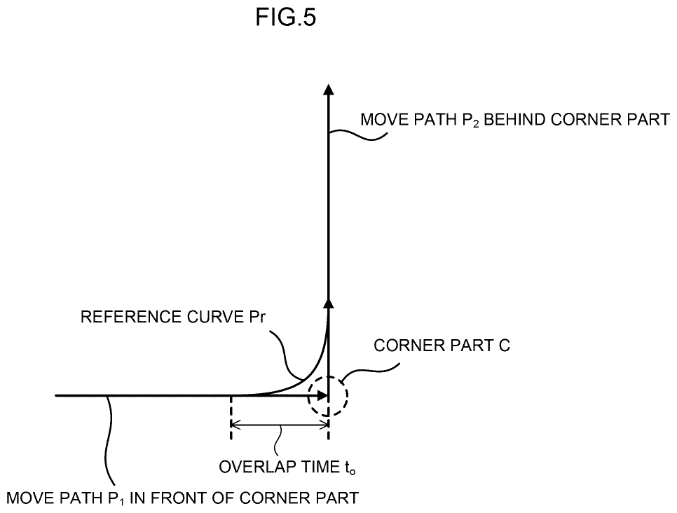

The reference curve former 120 is configured to form a reference curve in which a move path P₁ overlaps with a move path P₂, which are paths in front of and behind a corner part C detected by the corner detector 110. The reference curve is referred for forming a curve to be inserted in the corner part. The reference curve according to the embodiment shall be a curve along which a moving object moves when acceleration/deceleration processing is applied to the movement along the move paths P₁, P₂ in front of and behind the corner part C and when the move paths P₁ and P₂ are further overlapped by an overlap time tₒ. The overlap time tₒ is adjusted such that a path error of the reference curve falls in the range of a predefined given acceptable error. FIG. 4 is a graph showing a relation between a move speed on the move path P₁ and a move speed on the move path P₂ when forming the reference curve. As illustrated in FIG. 4, the reference curve former 120 conducts the acceleration/deceleration on the move path P₁, P₂ in front of and behind the corner part to have repetitive smooth acceleration. Then, a determination is made about a curve that will be a move path of the moving object when the movement is started on the move path P₂ behind the corner part at the overlap time tₒ before a timing of completion of the movement on the move path P₁ in front of the corner part to thereby form the reference curve. The overlap time tₒ may be determined by using a time constant applied to each axis as a reference value. FIG. 5 shows an example of the reference curve formed by the reference curve former 120. The reference curve is formed by synthesizing movements in which the move speeds in the directions of the move paths P₁, P₂ in front of and behind the corner part are accelerated/decelerated smoothly. Thus, even when the moving object is moved at a synthesized speed along this reference curve, the waves of the speed component in the direction of each move path and of the speed component and the acceleration component in each feed axis are suppressed, and the fluctuations in the speed change do not occur.

The corner curve shaper 130 is configured to create a curve based on the reference curve formed by the reference curve former 120, and create a move path in which the formed curve is inserted into the corner part detected by the corner detector 110. The corner curve shaper 130 forms a curve that passes at least one predetermined reference position on the reference curve. The predetermined reference position may have, for example, the largest curvature on the reference curve.

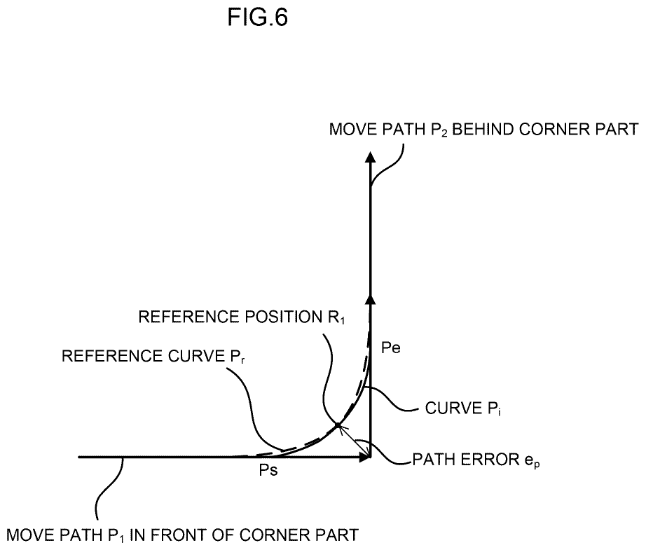

FIG. 6 shows an example of a curve to be inserted into the corner part by the corner curve shaper 130. The example of FIG. 6 shows a position where the curvature is largest on the reference curve Pᵣ as a reference position R₁, and a curve passing the reference position R₁ is formed. In this case, the corner curve shaper 130 inserts a curve Pᵢ passing the reference position R₁ into the corner part C, the curve Pᵢ having a predetermined point Ps as a start point on the move path in front of the corner part and a predetermined point Pe as an end point on the move path behind the corner part. The positions of the start point Ps and the end point Pe may be closer to the corner part than the positions at which the reference curve Pᵣ is in contact with the move paths P₁, P₂. That is to say, the curve is formed by using a second acceleration/deceleration time constant which is smaller than the acceleration/deceleration time constant when forming the reference curve. The curve with smaller acceleration/deceleration time constant is formed while adjusting the position having the large curvature so that a path error eₚ of the curve can be reduced without increasing shocks so much. Then, the move path P₁ in front of the corner part is replaced with a move path P_{1′} with its end point being the point Ps and the move path P₂ behind the corner part is replaced with a move path P_{2′} with its start point being the point Pe, thereby creating a new move path. The inserted curve only needs to have the position, the speed, and the acceleration on both ends being almost continuous with the move paths P_{1′}, P_{2′}, respectively in front of and behind the corner part. In addition, it is preferable that the inserted curve can be differentiated twice or more times. Such a curve insertion is publicly known in, for instance, Japanese Patent Laid-Open Publication Nos. H9-190211 and H10-320026, and it is therefore not described in detail herein.

The predetermined reference position on the reference curve referred by the corner curve shaper 130 while forming a curve to be inserted into the corner part may be a position closer to the corner part, for instance. A curve that passes through this position has a path error equal to that of the reference curve. Furthermore, the reference position may be a position where the reference curve has the largest local curvature, i.e., where the rate of change in the curvature is zero. The corner curve shaper 130 may define multiple positions on the reference curve as reference positions.

The curve speed planner 140 is configured to create a speed plan when moving on the curve inserted by the corner curve shaper 130. In creating a speed plan, the curve speed planner 140 sets a speed during passing through the reference position to a speed that is almost the same as the speed during moving on the reference curve. With respect to speeds in the other positions on the curve, a speed plan may be created so as to conduct accelerate/decelerate to have repetitive smooth acceleration.

The each-axis accelerator/decelerator 150 calculates a stroke for each control cycle of each axis of the industrial machine 3 based on the move path created by the corner curve shaper 130 and the speed plan created by the curve speed planner 140, so as to conduct acceleration/deceleration processing on the calculated stroke.

Then, the controller 160 controls the motor for each component of the industrial machine 3 on the basis of the stroke subjected to the acceleration/deceleration processing by the each-axis accelerator/decelerator 150 and the data about a spindle rotation command.

Since the control device 1 with the above-described configuration can determine the speed to pass the corner part so that the rate of change of the speed in each direction monotonically varies when the moving object is moved along the path with the curved corner part, the behavior in each direction is stabilized and the shocks to the machine are reduced. In addition to that, the improvement in accuracy of machining the corner part is expected.

The present invention has been described with reference to the above-described embodiment, but the present invention is not limited to the embodiment. Thus, the present invention can be implemented in various aspects by modifying the invention appropriately.

For example, the above-described embodiment shows the example in which the start point Ps and the end point Pe of the curve to be inserted are closer to the corner part than the positions where the reference curve Pᵣ is in contact with the move paths P_{1′} and P_{2′}. However, the start point Ps and the end point Pe of the curve to be inserted should be away from the corner part than the position where the reference curve Pᵣ is in contact with the move paths P_{1′}, P_{2′}. so that the time to pass along the curve can be shortened. This is because the jerk occurring in a direction perpendicular to the move paths P_{1′}, P_{2′} is reduced and thereby the speed when passing through the corner can be increased further.

### Reference Numerals List

1 Control Device
3 Industrial Machine
11 CPU
12 ROM
13 RAM
14 Non-Volatile Memory
15, 18, 19 Interface
16 PLC
17 I/O Unit
22 Bus
30 Axis Control Circuit
40 Servo Amplifier
50 Servo Motor
60 Spindle Control Circuit
61 Spindle Amplifier
62 Spindle Motor
63 Position Coder
70 Display Device
71 Input Device
72 External Device
100 Analyzer
110 Corner Detector
120 Reference Curve Former
130 Corner Curve shaper
140 Curve Speed Planner
150 Each-Axis Accelerator/Decelerator
160 Controller
200 Control Program

1. A control device for driving a feed axis of an industrial machine based on a control program, comprising:
an analyzer for analyzing a command in the control program;
a corner detector for detecting a corner part at which the direction of a move path is discontinuous, based on a result of an analysis conducted by the analyzer;
a reference curve former for conducting acceleration/deceleration processing on movements on move paths in front of and behind the corner part so as to form curves overlapped by a predetermined overlap time as a reference curve;
a corner curve shaper for creating a curved move path on the corner part by inserting a curve that passes at least one predetermined reference position on the reference curve; and
a curve speed planner for creating a speed plan concerning a movement on the curved move path,
wherein the curve speed planner determines a speed in the reference position while moving along the move path based on a move speed in the reference position on the reference curve.

2. The control device according to claim 1, wherein the reference position includes a position in which a curvature is largest on the reference curve.

3. The control device according to claim 1, wherein the reference position includes a position that is closest to the corner part on the reference curve.

4. The control device according to claim 1, wherein the reference position includes a position in which a local curvature is largest on the reference curve.

5. The control device according to claim 1, wherein the acceleration/deceleration processing conducted on the movements on the move paths in front of and behind the corner part by the reference curve former is that acceleration is continuously accelerated/decelerated.

6. The control device according to claim 1, wherein the overlap time is determined based on a time of an acceleration/deceleration time constant applied for each axis.

7. The control device according to claim 1, wherein the curve speed planner sets the speed in the reference position while moving along the move path to be approximately the same as the move speed in the reference position on the reference curve.

8. The control device according to claim 1, wherein the corner curve shaper forms a curve by using a second acceleration/deceleration time constant that is smaller than the acceleration/deceleration time constant used in forming the reference curve, and such that a distance from the corner to a point where the curvature is largest is equivalent to that of the reference curve.

9. A computer-readable recording medium that records a program for operating a computer as a control device for driving a feed axis of an industrial machine based on a control program,
wherein the computer is operated as:
an analyzer for analyzing a command in the control program;
a corner detector for detecting a corner part at which a direction of a move path is discontinuous based on a result of an analysis conducted by the analyzer;
a reference curve former for conducting acceleration/deceleration processing on movements on move paths in front of and behind the corner part so as to form curves overlapped by a predetermined overlap time as a reference curve;
a corner curve shaper for creating a curved move path on the corner part by inserting a curve that passes at least one predetermined reference position on the reference curve; and
a curve speed planner for creating a speed plan concerning a movement on the curved move path, and
wherein the curve speed planner determines a speed in the reference position while moving along the move path based on a move speed in the reference position on the reference curve.
